(19) United States
(12) Patent Application Publication
(10) Pub. No.: US 2013/0173246 A1
(43) Pub. Date: Jul. 4, 2013

(54) Voice Activated Translation Device

(71) Applicants: Sheree Leung, Annandale, NJ (US); Ethan Leung, Annandale, NJ (US)

(72) Inventors: Sheree Leung, Annandale, NJ (US); Ethan Leung, Annandale, NJ (US)

(21) Appl. No.: 13/343,255

(22) Filed: Jan. 4, 2012

(51) Int. Cl. G06F 17/28

(52) U.S. Cl. 704/2; 704/E11.001

(57) ABSTRACT

A voice activated translation device comprising: a housing, where the housing comprises, a microprocessor to translate a message; a screen to display one or more languages to be translated; a speaker positioned by the screen, where the speaker plays a translated message; a microphone positioned by the speaker, where the microphone receives the message to be translated; and a plurality of buttons positioned on the housing, where the plurality of buttons operate the housing; and an earpiece worn by a first user, where the earpiece comprises, an earbud to enable the first user to hear the translated message; a hook to securely attach the earpiece to the first user's ear; and a mouthpiece, where the mouthpiece receives the message to be translated. The voice activated translation device processes and plays translated messages to enable people of different speaking languages to converse.

### BACKGROUND OF THE INVENTION

1. Field of the Invention

The present invention relates to a translation device wherein a portable handheld electronic device that enables a person to speak into the device where it then automatically translates what the person just said into a preselected language of the user's choice.

2. Description of Related Art

Traveling is an enjoyable experience shared by people around the world. Many people embrace new sites, cultures and experiences through their travels inviting all that the place has to offer. Often the most difficult challenges are faced with language barriers. Ideally before a person travels they will learn the language of the place where they are going to ensure that they can communicate with the locals. This is not always the case. Most of the time, the traveler may learn a few phrases hoping that will get them by until they are able to find someone who speaks their native tongue. Some travelers may encounter great frustration if they find themselves unable to communicate with anyone often resorting to hand gestures and a game of charades for communication.

With the globalization of many businesses and corporations many people in the work force are finding that communication with others who do not speak their language is becoming a more normal circumstance. Some business people may purchase translation books to assist them in communications. Many times these books do not translate the local sayings or common idiomatic expressions leaving the user embarrassed when what they meant to say is not translated in the right way.

Over the years some devices have been developed to assist persons when traveling or simply needing something translated. For example, U.S. Pat. No. 4,381,551 by Ikuo Kanou et. al. discloses an electronic translator. The translator appears like a small calculator wherein the user enters a word on a keypad and then the translated word appears on the screen. This enables basic word translations but not full sentence structure. Alternatively, U.S. Pat. No. 4,443,856 by Shintaro Hashimoto et. al. discloses an electronic translator for modifying and speaking out sentences. The translator speaks the words entered so that the user may hear how the translated words are spoken.

While these devices are handy for translation they still require the user to enter the words to be translated which may be a tedious and time consuming task. It would be desirable in the art to provide a translator that enables a user to speak into the device rather than having to manually input the information. It would also be beneficial in the art to provide a translator that plays the sentence that was just translated for the user to hear.

### SUMMARY OF THE INVENTION

In view of the foregoing disadvantages inherent in the prior art, the general purpose of the present invention is to provide a voice activated translation device, configured to include all of the advantages of the prior art, and to overcome the drawbacks inherent therein.

Accordingly, an object of the present invention is to provide a translator that enables a user to say a message into the device whereby the device will then play the translated message.

Another object of the present invention is to provide a translator that enables two users to carry on an entire conversation by simply speaking and playing messages translated through the translator.

To achieve the above objects, in an aspect of the present invention, a voice activated translation device is described comprising: a housing, where the housing comprises, a microprocessor to translate a message; a screen to display one or more languages to be translated; a speaker positioned by the screen, where the speaker plays a translated message; a microphone positioned by the speaker, where the microphone receives the message to be translated; and a plurality of buttons positioned on the housing, where the plurality of buttons operate the housing; and an earpiece worn by a first user, where the earpiece comprises, an earbud to enable the first user to hear the translated message; a hook to securely attach the earpiece to the first user's ear; and a mouthpiece, where the mouthpiece receives the message to be translated. The voice activated translation device processes and plays translated messages to enable people of different speaking languages to converse.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a voice activated translation device in accordance with an exemplary embodiment of the present invention.

### DETAILED DESCRIPTION OF THE DRAWINGS

The present invention relates to a translation device wherein a portable handheld electronic device that enables a person to speak into the device where it then automatically translates what the person just said into a preselected language of the user's choice. The voice activated translation device better assists two people who speak different languages to communicate. During use, a user may place an earpiece over their ear and then have the second user speak into a microphone on the device. The voice activated translation device then translates what was said and plays the translated message through the earpiece to enable the first person to know what was said. Alternatively, the first user may speak into a mouthpiece attached to the earpiece, the voice activated translation device then translates the message and then plays the translated message through a speaker on the device. This way, two individuals who may not normally be able to communicate may carry on a conversation without actually knowing the other's language.

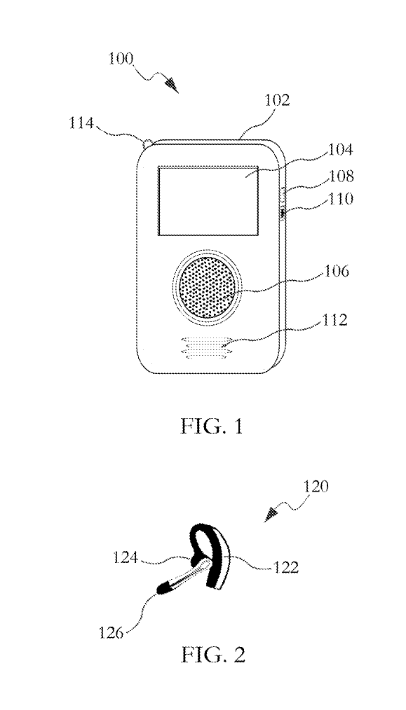

Turning now descriptively to the drawings, referring to FIG. 1, a perspective view of a voice activated translation device 100 is shown in accordance with an exemplary embodiment of the present invention. The voice activated translation device 100 includes a housing 102 to store and contain the electrical components of the voice activated translation device 100. The housing 102 may be generally rectangular in shape or may have a square or even circular embodiment. Within the housing 102 may be a receiver and a microprocessor among a plurality of other components. The housing may be waterproof to ensure that water does not damage the device 100. The housing 102 may include a screen 104, a speaker 106, a plurality of buttons 108, 110, and a microphone 112. The housing 102 cooperatively operates with an earpiece 120, and their relationship will be better explained below.

The screen 104 is positioned on a front face of the housing 102. The screen 104 may be a touch screen to enable the user to maneuver through the menu selections by simply using their finger. The screen 104 enables the user to select one or more languages for translation. For example, the user may select to translate between English and Korean thereby permitting an English speaker and a Korean speaker to converse. The languages are processed by the microprocessor within the housing 102. The microprocessor may translate major world languages spoken by large populations of the world. The languages may range from English, Spanish, French, German, Mandarin, Hindi, Arabic, Portuguese, Russian, Japanese, Punjabi, Bengali, Italian, Polish, Portuguese, Vietnamese and the like. The microprocessor may translate entire sentences for fluid communication between the first and second user. The microprocessor may also be programmed to translate sayings or common idiomatic expressions to ensure that meanings are not lost in translation.

The speaker 106 may be positioned below the screen 104 in a central portion of the housing 102. The speaker 106 enables the voice activated translation device 100 to make sounds. The speaker 106 may sound or play the translated message to enable a second user to hear what the first user said. Below the speaker 106 may be the microphone 112. The microphone 112 is the portion of the housing 102 where the second user speaks a message for message translation.

Against a lateral wall of the housing 102 may be a plurality of buttons. One of the buttons may be an activation button 108 to power on and off the voice activated translation device 100. Within the housing 102 may be a battery pack for battery power activation. The batteries may be rechargeable. Alternatively, the housing 102 may include a solar panel to enable the voice activated translation device to run off of solar energy.

Another button may be a volume button 110 to enable the user to increase or decrease the volume level. Positioned to an edge of the housing may be a keychain ring 114 to enable the user to attach a key ring to the housing 102. This way the voice activated translation device 100 is readily available whenever needed by the user.

Associated with the housing 102 is the earpiece 120. The earpiece 120 may be worn by the first user to hear the translated message. The earpiece 120 includes an earbud 124 that fits into the user's ear to enable them to hear the translated message. The earbud 124 may be padded for additional comfort, or may include replaceable covers to adapt to various users ear sizes. The earpiece 120 may include a padded hook 122 that wraps over the first user's ear for greater stability and comfort while listening. Finally, the earpiece 120 may include a mouthpiece 126. The mouthpiece 126 allows the first user to speak a message into the mouthpiece 126 and then the voice activated translation device 100 translates what they said and plays the translated message through the speaker 106 on the housing 102. The earpiece 120 may be connected to the housing 102 with a cord (not shown). Alternatively, the earpiece 120 may interface with the housing 102 utilizing a Bluetooth® wireless connection. This would enable wireless use of the voice activated translation device 100.

For use, a first user wears the earpiece 120 and powers on the housing 102 with the activation buttons 108. Then the first user may select the languages for translation. Next, the second user may speak into the microphone 112 whereby the internal microprocessor translates the spoken message. Once the microprocessor translates the message, the housing 102 communicates with the earpiece 120, either through a cord or Bluetooth®, by sending the translated message to the earpiece 120. Then the earpiece 120 may play the translated message into the first user's ear through the earbud 124. Alternatively, the first user may speak into the mouthpiece 126 first, then the message is sent to the housing 102 via Bluetooth® where then the microprocessor translates the message and finally plays the translated message through the speaker 106. The message relay may continue back and forth between the first and second users as needed to complete the conversation.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A voice activated translation device comprising:
a housing, where the housing comprises,
a microprocessor within the housing, where the microprocessor translates a message;
a screen positioned on a front face of the housing, where the screen displays one or more languages to be translated;
a speaker positioned by the screen, where the speaker plays a translated message;
a microphone positioned by the speaker, where the microphone receives the message to be translated; and
a plurality of buttons positioned on the housing, where the plurality of buttons operate the housing; and
an earpiece worn by a first user, where the earpiece comprises,
an earbud, where the earbud fits into a user's ear to enable them to hear the translated message;
a hook to securely attach the earpiece to the first user's ear; and
a mouthpiece, where the mouthpiece receives the message to be translated
wherein the microphone and the mouthpiece receive the message to be translated, the microprocessor translates the message and speaker and the earbud play the translated message to enable a conversation between a first user and a second user.

2. The voice activated translation device according to claim 1, wherein the screen is a touchscreen.

3. The voice activated translation device according to claim 1, wherein the plurality of buttons includes an activation button and a volume button.

4. The voice activated translation device according to claim 1, wherein the housing is battery powered.

5. The voice activated translation device according to claim 1, wherein the housing utilizes solar energy.

6. The voice activated translation device according to claim 1, wherein the earpiece and the housing communicate via a cord.

7. The voice activated translation device according to claim 1, wherein the earpiece and the housing communicate via a Bluetooth® wireless connection.

8. The voice activated translation device according to claim 1, wherein the housing includes a keychain ring.

9. A method of use for a voice activated translation device comprising the steps of:
wearing an earpiece by a first user;
activating a housing;
selecting one or more languages to be translated;
speaking a message into a microphone on the housing by a second user;
listening to a translated message through an earbud on the earpiece;
speaking a message into a mouthpiece on the earpiece by the first user; and
listening to the translated message through a speaker positioned on the housing.

10. The method of use for a voice activated translation device according to claim 9, further comprising the step of continuing a conversation utilizing the voice activated translation device until the conversation is complete.
